(19) United States
(12) Patent Application Publication
(10) Pub. No.: US 2026/0073703 A1
(43) Pub. Date: Mar. 12, 2026

(54) METHOD AND APPARATUS FOR COLLECTING VIDEO OF VEHICLE IN ACCIDENT

(71) Applicants: HYUNDAI MOTOR COMPANY, SEOUL (KR); KIA CORPORATION, SEOUL (KR)

(72) Inventors: Jae Kyu Yu, Hwaseong-si (KR); Dae Han Choi, Hwaseong-si (KR); Young Man Kim, Hwaseong-si (KR); Young Seok Jeon, Hwaseong-si (KR)

(73) Assignees: HYUNDAI MOTOR COMPANY, SEOUL (KR); KIA CORPORATION, SEOUL (KR)

(21) Appl. No.: 19/173,995

(22) Filed: Apr. 9, 2025

(30) Foreign Application Priority Data
Sep. 11, 2024 (KR) 10-2024-0124183

(51) Int. Cl. G06V 20/56; G06T 7/11; G06T 7/62; H04W 4/029

(52) U.S. Cl. CPC G06V 20/56; G06T 7/11; G06T 7/62; H04W 4/029; G06T 2207/30252

(57) ABSTRACT

A method and apparatus for collecting a video of a vehicle in an accident includes obtaining position information of the accident vehicle at a time when an accident occurs, identifying, based on the position information, a nearby vehicle located within a predetermined distance from the accident vehicle, obtaining, from the nearby vehicle, a video having a reduced data size of the video capture of the accident vehicle, and outputting the video having the reduced data size.

### CROSS REFERENCE TO RELATED APPLICATIONS

The present application claims priority to Korean Patent Application No. 10-2024-0124183, filed on Sep. 11, 2024 in the Korea Intellectual Property Office, the entire contents of which are incorporated herein by reference.

### TECHNICAL FIELD

The present disclosure relates to a method and apparatus for collecting a video of a vehicle in an accident.

### BACKGROUND

The statements in this section merely provide background information related to the present disclosure and do not necessarily constitute prior art.

When a vehicle accident occurs, collecting a video recording of the accident scene is very important for accurately identifying and analyzing the accident situation. However, conventional methods and apparatuses of vehicles for collecting accident videos suffer from slow data transmission speed due to a lack of separate processing when transmitting the video recording of the accident situation to other vehicles or servers.

Similarly, the slow data transmission issue has persisted in the conventional method and apparatus for a vehicle to provide traffic information including road conditions because of the lack of separate data processing when transmitting the event information to another vehicle or server.

Therefore, there is a need for a method and apparatus for collecting accident videos, which can improve data transmission speed.

### SUMMARY

An object of the present disclosure is to provide a method and apparatus for collecting a video of a vehicle in an accident. More specifically, the object of the present disclosure is to provide a method and apparatus for improving the data transmission speed by identifying a nearby vehicle based on position information of an accident vehicle, and obtaining a video of the accident vehicle from the nearby vehicle, while reducing the data size of the video before the nearby vehicle transmits it to the video collecting device.

The technical objects of the present disclosure are not limited to those described above, and other technical objects not mentioned above may be understood clearly by those skilled in the art from the descriptions given below.

An embodiment of the present disclosure provides a method of collecting a video capture of an accident vehicle, the method comprising obtaining position information of the accident vehicle at a time when an accident occurs, identifying, based on the position information, a nearby vehicle located within a predetermined distance from the accident vehicle, obtaining, from the nearby vehicle, a video having a reduced data size of the video capture of the accident vehicle, and outputting the video having the reduced data size.

Another embodiment of the present disclosure provides an apparatus for collecting a video capture of an accident vehicle, comprising at least one memory configured to store instructions, and at least one processor, wherein the at least one processor executes the instructions for causing the processor to perform the steps of obtaining position information of the accident vehicle at a time when an accident occurs, identifying, based on the position information, a nearby vehicle located within a predetermined distance from the accident vehicle, obtaining, from the nearby vehicle, a video having a reduced data size of the video capture of the accident vehicle, and outputting the video having the reduced data size.

According to one embodiment of the present disclosure, it is possible to save network bandwidth while providing sufficient information for analyzing the accident situation by reducing the video data size before transmitting the video data of the accident vehicle to the video collecting device.

According to one embodiment of the present disclosure, it is possible to increase the speed of data transmission by reducing the data size of the video transmitted to the video collecting device from the nearby vehicle.

The technical effects of the present disclosure are not limited to the technical effects described above, and other technical effects not mentioned herein may be understood to those skilled in the art to which the present disclosure belongs from the description below.

### BRIEF DESCRIPTION OF THE FIGURES

FIG. 1 is a diagram illustrating an accident vehicle, a nearby vehicle, and a video collecting device, according to at least one embodiment of the present disclosure.

FIG. 2 is a diagram illustrating a view of a roadway during an accident, according to at least one embodiment of the present disclosure.

FIG. 3 is a schematic flowchart illustrating a method of collecting a video capture of an accident vehicle, according to at least one embodiment of the present disclosure.

FIG. 4 is a diagram illustrating a method of calculating a minimum angle, according to at least one embodiment of the present disclosure.

FIG. 5 is a diagram illustrating a method of selecting a partial area from the entire area based on a minimum angle, according to at least one embodiment of the present disclosure.

FIG. 6 is a schematic diagram of an illustrative configuration of a computing device that may be used to implement the apparatuses and methods described herein.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

In the present disclosure, shrinkage and reduction may be used interchangeably. For example, the process of shrinking the size of certain data and the process of reducing the size of certain data may be the same.

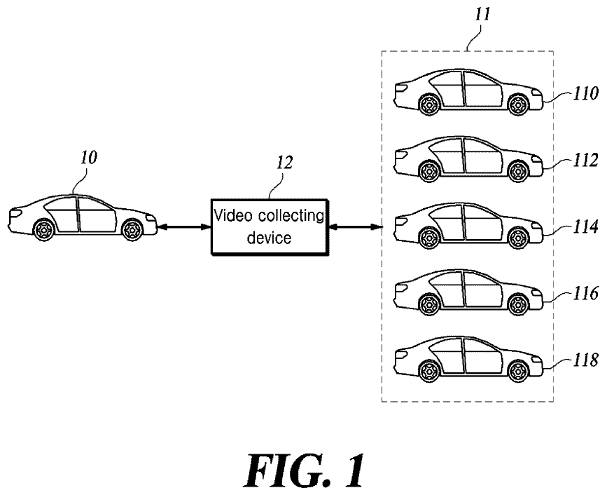

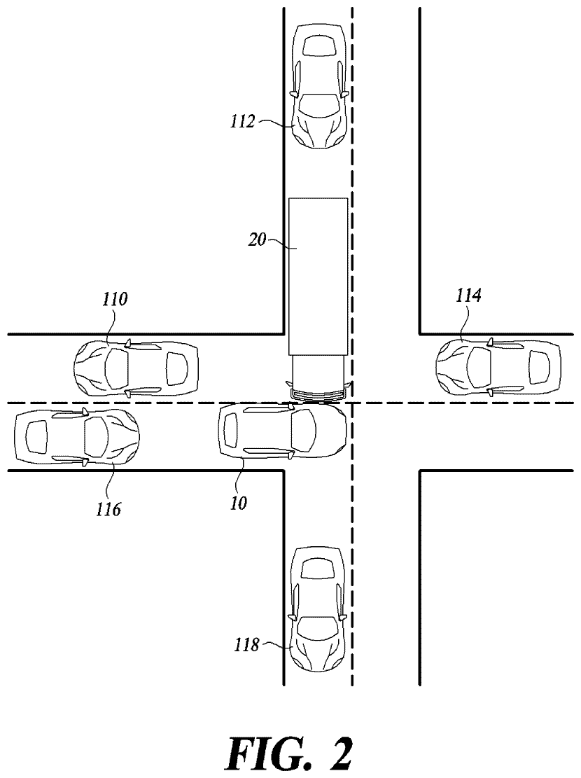

FIG. 1 is a diagram illustrating an accident vehicle, a nearby vehicle, and a video collecting device, according to at least one embodiment of the present disclosure. FIG. 2 is a diagram illustrating a view of a roadway during an accident, according to at least one embodiment of the present disclosure.

Referring to FIG. 1, an accident vehicle (vehicle involved in an accident) 10, a nearby vehicle (vehicles near the accident) 11, and a video collecting device 12 are shown. The nearby vehicle 11 may be one or more vehicles located within a certain distance from the accident vehicle 10. The distance may be preset. The nearby vehicle 11 may include a first nearby vehicle 110, a second nearby vehicle 112, a third nearby vehicle 114, a fourth nearby vehicle 116, and a fifth nearby vehicle 118. The first, second, third, fourth, and fifth are randomized and do not necessarily imply an order of increasing distance from the accident vehicle. Illustrated in FIG. 2 are the accident vehicle 10, another vehicle or striking vehicle 20 involved in a collision accident, the first nearby vehicle 110, second nearby vehicle 112, third nearby vehicle 114, fourth nearby vehicle 116, and fifth nearby vehicle 118.

The accident vehicle 10 and the nearby vehicle 11 may be Internet-connected vehicles. The Internet-connected vehicle may be a connected car. The accident vehicle 10 and the nearby vehicle 11 may communicate with each other by using the Internet. The process of exchanging information between the accident vehicle 10 and the nearby vehicle 11 may be vehicle-to-vehicle (V2V) communication.

The accident vehicle 10 and nearby vehicle 11 may have a video capture device or camera (not shown) attached to them. The camera may be a device that records the vehicle interior, a device that records the vehicle exterior, or a device that records both the vehicle interior and exterior. The camera may be a dash cam. The dash cam may be an external dash cam or an internal dash cam. The internal dash cam may be referred to as a built-in camera.

The accident vehicle 10 and nearby vehicle 11 may have a display (not shown) attached to them. The video collecting device 12 may output a video with reduced data size using attached display. The display may be installed in various locations within the vehicle. The display may include one or more of an instrument cluster display, a center display, a head-up display, a passenger display, or a rear seat entertainment display. The display may be implemented using panel technologies such as a high-resolution Thin Film Transistor (TFT) or an Organic Light Emitting Diode (OLED), and may include touch input or gesture recognition functionality.

The video collecting device 12 may be implemented by using a server. The server may be in the form of one of a cloud server, a web server, a database server, and an application server, or a combination thereof.

In FIG. 1, the accident vehicle 10, the nearby vehicle 11, and the video collecting device 12 are arranged in a row, but this configuration is for illustrative purposes only, and in practice, the accident vehicle 10 and the nearby vehicle 11 may be arranged as shown in FIG. 2.

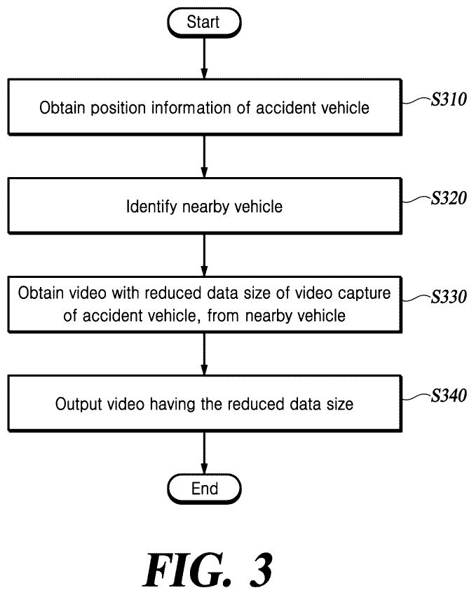

FIG. 3 is a schematic flowchart illustrating a method of collecting a video capture of an accident vehicle, according to at least one embodiment of the present disclosure.

Referring to FIG. 3, the video collecting device 12 may obtain position information of the accident vehicle 10 when an accident occurs (S310). The position information may be information based on a Global Navigation Satellite System (GNSS). For example, when the video collecting device 12 is informed that an accident occurred between the accident vehicle 10 and the striking vehicle 20, the video collecting device 12 may obtain the position information of the accident vehicle 10 at the time the accident occurred based on the position information of the accident vehicle 10 recorded over time.

Based on the position information of the accident vehicle 10, the video collecting device 12 may identify the vehicles located within a certain distance from the accident vehicle 10, that is the nearby vehicle 11 (S320). For example, the video collecting device 12 may identify, based on the obtained position information of the accident vehicle 10, vehicles located within a certain radius from the accident vehicle 10 and the striking vehicle 20, such as the first nearby vehicle 110, second nearby vehicle 112, third nearby vehicle 114, fourth nearby vehicle 116, and fifth nearby vehicle 118 among vehicles that can communicate with the video collecting device 12 by using the Internet.

The video collecting device 12 may obtain, from the nearby vehicle 11, a video with a reduced data size of the video capture of the accident vehicle 10 (S330). For example, the video collecting device 12 may obtain, from the first nearby vehicle 110, a video generated based on the video capture of the accident vehicle 10. From each of the second nearby vehicle 112, third nearby vehicle 114, fourth nearby vehicle 116, and fifth nearby vehicle 118, the video collecting device 12 may likewise obtain a video generated based on the video in which the accident vehicle 10 is captured. The video capture of the accident vehicle 10 may be a video captured by using a camera (not shown) attached to the nearby vehicle 11. The video captured by each of the nearby vehicles may be a video taken of the same scene from different locations and at different angles. The video with reduced data size of the video capture of the accident vehicle 10 may be a processed video with its frame reduced in data size by cropping a partial area from the entire area out of one or more of the plurality of frames included in the original video. The process of cropping a partial area from the entire area may also be represented as selecting a partial area from the entire area.

In one example, the process of selecting a partial area among the entire area may include selecting the partial area among the entire area based on a value calculated by at least one of distances between the accident vehicle 10 and the nearby vehicle 11 and an overall width of the accident vehicle 10. The value calculated by at least one of the distances between the accident vehicle 10 and the nearby vehicle 11 and the overall width of the accident vehicle 10, may be a minimum angle. A method of calculating the minimum angle based on the distance between the accident vehicle 10 and the nearby vehicle 11 and the overall width of the accident vehicle 10 is described in more detail below.

The video collecting device 12 may output a video with reduced data size (S340). For example, the video collecting device 12 may output a video with reduced data size using a display mounted in one or more of the accident vehicle 10 and the nearby vehicle 11. The display may be installed in various locations within the vehicle. The display may include one or more of an instrument cluster display, a center display, a head-up display, a passenger display, or a rear seat entertainment display. The display may be implemented using panel technologies such as a high-resolution Thin Film Transistor (TFT) or an Organic Light Emitting Diode (OLED), and may include touch input or gesture recognition functionality.

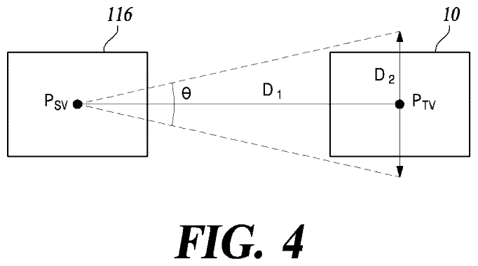

FIG. 4 is a diagram illustrating a method of calculating a minimum angle, according to at least one embodiment of the present disclosure.

Referring to FIG. 4, the accident vehicle 10 and the fourth nearby vehicle 116 are illustrated. Referring to FIG. 2, the fourth nearby vehicle 116 photographs the accident vehicle 10 by using a front video capture device or front-view camera and obtains a video of the accident vehicle 10. Assuming that the center of the accident vehicle 10 is the P_{TV} and the center of the fourth nearby vehicle 116 is the P_{SV}, the distance from the Pry to the P_{SV} is D₁. The unit of D₁ may be the meter. An arbitrary value set based on the overall width of the accident vehicle 10 is D₂. D₂ may be equal to or greater than the overall width of the accident vehicle 10. The unit of D₂ may be the meter. Based on D₁ and D₂, the minimum angle may be calculated. The expression for calculating the minimum angle is shown in Equation 1. The minimum angle may be represented by θ.

$$θ = 2 {tan}^{- 1} ( \frac{{{D}_{2}}^{} {/}_{2}}{{D}_{1}} ) \qquad Equation 1$$

The minimum angle may be the smallest angle at which the entirety of the accident vehicle 10 is visible in the field of view of the nearby vehicle 11. For example, when selecting a partial area among the entire area, the minimum angle may be calculated to set a limit to prevent the portion of the video capture of the accident vehicle 10 from being cropped. For instance, the fourth nearby vehicle 116 may crop the frame in which the accident vehicle 10 is captured only within an angle range that is greater than or equal to the minimum angle.

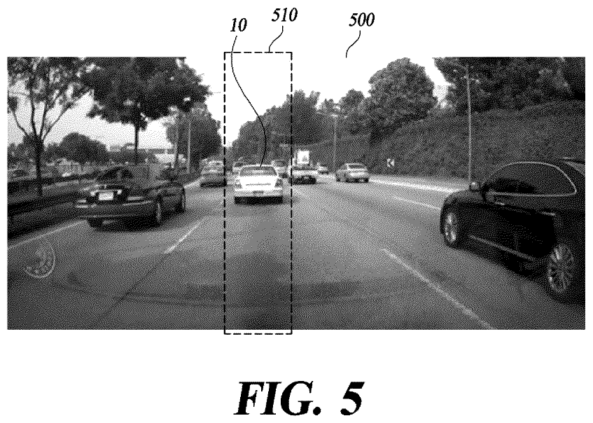

FIG. 5 is a diagram illustrating a method of selecting a partial area from the entire area based on a minimum angle, according to at least one embodiment of the present disclosure.

Referring to FIG. 5, one frame included in a video capture of the accident vehicle 10 is illustrated. The frame may be one included in the video of the accident vehicle 10, which is captured by a nearby vehicle located to the rear of the accident vehicle 10, such as the fourth nearby vehicle 116. The nearby vehicle 11 may calculate a minimum angle at which the entirety of the accident vehicle 10 is visible based on Equation 1 and may select a partial area 510 based on the minimum angle. For example, cropping from the entire area 500 may be performed based on the minimum angle. The partial area 510 is shown as a dotted line in the drawing to distinguish it from the entire area 500. The nearby vehicle 11 may select the partial area from the entire area to reduce the data size of the video to be transmitted to the video collecting device 12, thereby increasing the data transmission speed between the vehicle and the server.

As another example, the process of selecting a partial area among the entire area may include selecting the partial area from the entire area based on the size of the license plate of the accident vehicle 10. The nearby vehicle 11 may further reduce the data size of the frame by cropping it based on the size of the license plate of the accident vehicle 10, after initially reducing the data size based on the distance between the accident vehicle 10 and the nearby vehicle 11 and the overall width of the accident vehicle 10. This process may be referred to as a further optimization process, as it is performed based on a partial area primarily selected according to the minimum angle, rather than on the entire frame area.

The video collecting device 12 according to at least one embodiment of the present disclosure may obtain, from the nearby vehicle 11, a video containing the selected partial area from the entire area, i.e., a video with a reduced data size compared to the original video. The process of selecting the partial area from the entire area may be performed by the nearby vehicle 11. In summary, to reduce the data size of the original video of the accident vehicle 10, the first nearby vehicle 110 through the fifth nearby vehicle 118 may select a partial area from the entire area for one or more of the frames included in the original video, based on one or more of the minimum angle and the size of the license plate of the accident vehicle 10, or a combination thereof. Then, the video with the reduced data size may be delivered from the first nearby vehicle 110 through the fifth nearby vehicle 118 to the video collecting device 12.

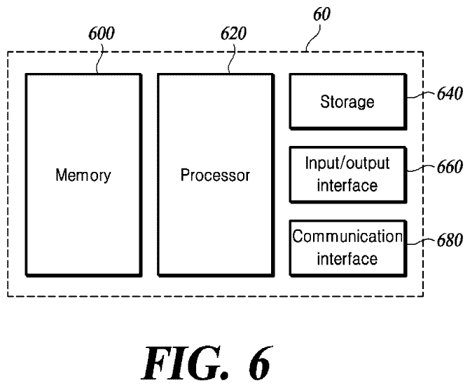

FIG. 6 is a schematic diagram of an illustrative configuration of a computing device that may be used to implement the apparatuses and methods described herein.

The computing device 60 may include some or all of a memory 600, a processor 620, a storage 640, an input/output interface 660, and a communication interface 680. The computing device 60 may be a stationary computing device, such as a desktop computer, server, or the like, as well as a mobile computing device, such as a laptop computer, smartphone, or the like. The computing device 60 may include any specialized hardware accelerator capable of efficiently processing computations on AI models. For example, the computing device 60 may include a graphic processing unit (GPU), a tensor processing unit (TPU), or a neural processing unit (NPU).

The memory 600 may store programs that cause the processor 620 to perform methods or operations in accordance with various embodiments of the present disclosure. For example, the program may include a plurality of instructions executable by the processor 620 and the plurality of instructions may be executed by the processor 620 to perform the methods or operations described above. The memory 600 may be a single memory or a plurality of memories. In this case, the information required to perform the methods or operations according to various embodiments of the disclosure may be stored in a single memory or stored divisively among the plurality of memories. When the memory 600 is composed of a plurality of memories, they may be physically separated. The memory 600 may include at least one of volatile memory and non-volatile memory. The volatile memory may include static random access memory (SRAM) or dynamic random access memory (DRAM), for example, and the non-volatile memory may include flash memory, for example.

The processor 620 may include at least one core capable of executing at least one set of instructions. The processor 620 may execute instructions stored in the memory 600. The processor 620 may be a single processor or a plurality of processors.

The storage 640 maintains stored data even when power to the computing device 60 is interrupted. For example, the storage 640 may include non-volatile memory or may include a storage medium such as magnetic tape, optical disk, or magnetic disk. Programs stored in the storage 640 may be loaded into the memory 600 before execution by the processor 620. The storage 640 may store files written in a program language, and programs generated by a compiler or the like may be loaded from the files into the memory 600. The storage 640 may store data to be processed by the processor 620 and/or data that has been processed by the processor 620.

The input/output interface 660 may provide an interface with an input device, such as a keyboard, mouse, etc. and/or with an output device, such as a display device, printer, etc. A user can trigger the execution of a program by the processor 620 via the input device and/or view the results of processing by the processor 620 via the output device.

The communication interface 680 may provide access to an external network. The computing device 60 may communicate with other devices via the communication interface 680.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed disclosure. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed disclosure is not to be limited by the above explicitly described embodiments but by the claims and equivalents thereof.

1. A method of collecting a video capture of an accident vehicle, the method comprising:
obtaining position information of the accident vehicle at a time when an accident occurs;
identifying, based on the position information, a nearby vehicle located within a predetermined distance from the accident vehicle;
obtaining, from the nearby vehicle, a video having a reduced data size of the video capture of the accident vehicle; and
outputting the video having the reduced data size.

2. The method of claim 1, wherein the video is generated based on selecting a partial area among an entire area for each of frames included in the video capture of the accident vehicle.

3. The method of claim 2, wherein selecting the partial area among the entire area for each of frames comprises:
selecting the partial area based on a value calculated by at least one of a distance between the accident vehicle and the nearby vehicle, and an overall width of the accident vehicle.

4. The method of claim 3, wherein selecting the partial area based on the value calculated by at least one of the distance between the accident vehicle and the nearby vehicle and the overall width of the accident vehicle comprises:
calculating, based on the distance and the overall width, a minimum angle at which the accident vehicle as a whole is visible in a field of view of the nearby vehicle; and
selecting the partial area based on the minimum angle.

5. The method of claim 2, wherein selecting the partial area of the entire area of each of the frames comprises:
selecting the partial area based on a size of a license plate of the accident vehicle.

6. An apparatus for collecting a video capture of an accident vehicle, comprising:
a memory storing computer-executable instructions; and
at least one processor configured to access the memory and execute the instructions, wherein the instructions comprise:
obtaining position information of the accident vehicle at a time when an accident occurs;
identifying, based on the position information, a nearby vehicle located within a predetermined distance from the accident vehicle;
obtaining, from the nearby vehicle, a video having a reduced data size of the video capture of the accident vehicle; and
outputting the video having the reduced data size.

7. The apparatus of claim 6, wherein the video is generated based on selecting a partial area among an entire area for each of frames included in the video capture of the accident vehicle.

8. The apparatus of claim 7, wherein selecting the partial area among the entire area for each of frames comprises:
selecting the partial area based on a value calculated by at least one of a distance between the accident vehicle and the nearby vehicle, and an overall width of the accident vehicle.

9. The apparatus of claim 8, wherein selecting the partial area based on the value calculated by at least one of the distance between the accident vehicle and the nearby vehicle and the overall width of the accident vehicle comprises:
calculating, based on the distance and the overall width, a minimum angle at which the accident vehicle as whole is visible in a field of view of the nearby vehicle; and
selecting the partial area based on the minimum angle.

10. The apparatus of claim 7, wherein selecting the partial area of the entire area of each of the frames comprises:
selecting the partial area based on a size of a license plate of the accident vehicle.
